(19) United States
(12) Patent Application Publication
(10) Pub. No.: US 2025/0216226 A1
(43) Pub. Date: Jul. 3, 2025

(54) SENSOR ASSEMBLY AND METHOD FOR ASSEMBLING THE SENSOR ASSEMBLY

(71) Applicant: Danfoss A/S, Nordborg (DK)

(72) Inventors: Ingvar Smari Kampp, Nordborg (DK); Hans-Henning Hansen, Nordborg (DK)

(21) Appl. No.: 18/978,194

(22) Filed: Dec. 12, 2024

(30) Foreign Application Priority Data
Dec. 28, 2023 (DE) 102023136764.1

(51) Int. Cl. G01D 11/24

(52) U.S. Cl. CPC G01D 11/24

(57) ABSTRACT

A sensor assembly includes an electrical connector with an annular seat, a media connector, at least one PCBA with a PCBA slot, a ground bracket with at least one ground bracket key inserted into the PCBA slot and at least one capsule, wherein an internal capsule annular seat abuts the annular seat. The disclosure further discloses a method for assembling the sensor assembly having the steps of connecting the ground bracket to the media connector; connecting the capsule to the media connector; inserting the PCBA into the capsule; and inserting the electrical connector at least partially into the capsule.

### CROSS-REFERENCE TO RELATED APPLICATION

This application claims foreign priority benefits under 35 U.S.C. § 119 to German Patent Application No. 102023136764.1 filed on Dec. 28, 2023, the content of which is hereby incorporated by reference in its entirety.

### TECHNICAL FIELD

The present invention pertains to a sensor assembly comprising an electrical connector with an annular seat, a media connector, at least one PCBA with a bottom PCBA key slot, a ground bracket with at least one ground bracket key inserted into the bottom PCBA slot and at least one capsule, wherein an internal capsule annular seat abuts the annular seat.

The invention is also directed at a method for assembling the sensor assembly, the method comprising the steps of
connecting the ground bracket to the media connector;
connecting the capsule to the media connector;
inserting the PCBA into the capsule; and
inserting the electrical connector at least partially into the capsule.

### BACKGROUND

Sensor assemblies are used for measuring physical properties of objects. The sensor assemblies are known to comprise electronic and mechanical components, which are designed to capture a physical property and output a signal indicative of said property.

Sensor assemblies typically comprise some intricate components, which may render the manufacturing of the assemblies problematic.

### SUMMARY

The aim of the present invention is to provide an improved sensor assembly and an improved method for providing the assembly, which overcome this problem.

This aim is achieved by a sensor assembly according to claim 1 and a method for assembling the sensor assembly according to claim 11. Preferable embodiments of the invention are subject to the dependent claims.

According to claim 1, a sensor assembly is provided, comprising an electrical connector with an annular seat, a media connector, at least one PCBA with a bottom PCBA key slot, a ground bracket with at least one ground bracket key inserted into the bottom PCBA slot and at least one capsule, wherein an internal capsule annular seat abuts the annular seat.

The capsule covers the interior of the sensor assembly while at the same time providing a contact surface for the electrical connector. The annular seat may furthermore provide an abutment or a stopper for positioning the electrical connector relative to the capsule in an axial direction of the sensor assembly. The annular seat may extend along the entire circumference of the capsule.

In a preferred embodiment of the invention, the outside of the capsule consists of a lower uniformly cylindrical portion and an upper crimped capsule portion and/or the capsule is cold drawn.

The cold drawing of the capsule facilitates its manufacture while its uniformly cylindrical outside provides a smooth surface for visual identifiers such as labels or engravings.

In particularly preferred embodiment of the invention, the upper crimped capsule portion secures the electrical connector to the capsule. The capsule may be crimped in a radially inwards direction such that the crimped capsule portion is at least partially inserted into a corresponding grove or recess of the electrical connector.

In another preferred embodiment of the invention, the electrical connector comprises an electrical connector key slot accommodating the ground bracket key. The electrical connector key slot may be a recessed portion at an outer circumference of the electrical connector, into which the ground bracket key may be inserted.

In another preferred embodiment of the invention, the PCBA comprises a top PCBA key slot accommodating the ground bracket key. The same ground bracket key may therefore be inserted into the electrical connector key slot and the top PCBA key slot.

In another preferred embodiment of the invention, the ground bracket comprises at least one ground bracket connection portion electrically connecting the ground bracket to the PCBA and/or to the capsule.

In another preferred embodiment of the invention, two PCBAs are provided, a top PCBA and a bottom PCBA, which are connected to each other via PCBA connection pins. The number of connection pins may be any number of pins.

In another preferred embodiment of the invention, the sensor assembly is a pressure, load and/or temperature sensor assembly. One or more sensor elements may be used. The sensor elements may be of the same or of different type.

In another preferred embodiment of the invention, the PCBA and the ground bracket are entirely provided inside the capsule relative to a radial direction of the capsule.

In another preferred embodiment of the invention, the ground bracket is providing an electrical connection between the PCBA, the capsule, and the media connector for shielding PCBA against EMC/EMI noise. The electrical connection between said components means that they are all electrically connected to each other to create a shield against EMC/EMI noise that might otherwise penetrate the PCBA.

The invention is also directed at a method for assembling the sensor assembly, the method comprising the steps of
connecting the ground bracket to the media connector;
connecting the capsule to the media connector;
inserting the PCBA into the capsule; and
inserting the electrical connector at least partially into the capsule.

The method steps may be carried out in the given or any logically possible order.

### BRIEF DESCRIPTION OF THE DRAWINGS

Further details and advantages of the invention are described with reference to the embodiments shown in the figures. The figures show:

FIG. 1: a perspective view of the sensor assembly;

FIG. 2: another perspective view of the sensor assembly;

FIG. 3: a sectional view of the sensor assembly;

FIG. 4: another sectional view of the sensor assembly;

FIG. 5: a view of the inside of the sensor assembly;

FIG. 6: another view of the inside of the sensor assembly;

FIG. 7: an exploded view of the inside of the sensor assembly;

FIG. 8: another exploded view of the inside of the sensor assembly;

FIG. 9: a partially transparent view of the inside of the sensor assembly;

FIG. 10: perspective views of the electric connector;

FIG. 11: a perspective view of the electric connector;

FIG. 12: an exploded view of a portion of the sensor assembly;

FIG. 13: a detailed view of the inside of the sensor assembly; and

FIG. 14: a detailed view of the capsule.

### DETAILED DESCRIPTION

FIG. 1 shows a perspective view of an embodiment of the sensor assembly 1. The sensor assembly 1 comprises an electrical connector 2, which may be provided at an upper axial end portion of the assembly 1. The electrical connector 2 may be provided adjacent to and/or above a capsule 3 containing various components of the assembly 1. The capsule 3 shields the components contained in it and may be made out of steel.

On the opposite side of the capsule 3, a hex 4 may be provided for turning the assembly 1 with a corresponding wrench. The assembly 1 may comprise a thread portion 6 on a lower axial end portion opposite the connector 2. A media connector 5 consists of the threaded portion 6 and the hex 4 and can form a seal against media leakage with or without a gasket.

The axial direction of the assembly 1 may correspond to the axial direction of its thread portion 6. The radial and circumferential directions may also be defined with reference to the substantial cylindrical tread portion 6.

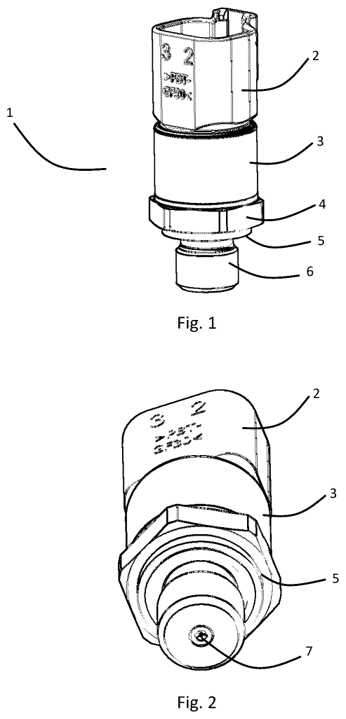

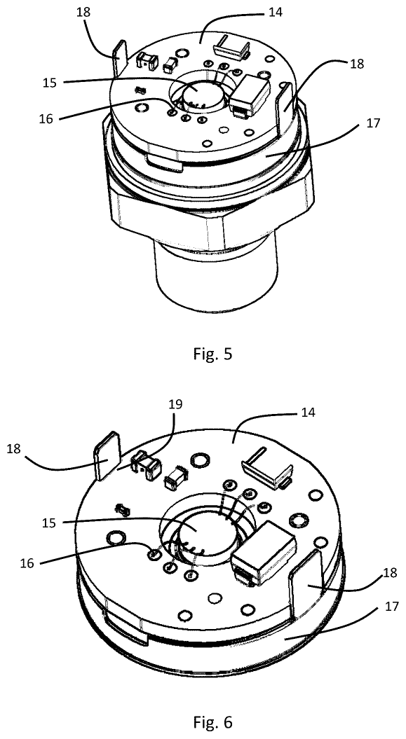

FIG. 2 shows another perspective view of the sensor assembly 1. In addition to the features shown in FIG. 1, a protection portion 7 is provided at the bottom of the assembly 1. The protection portion 7 may be arranged concentrically to the thread potion 6. The protection portion 7 may be a fluid passage and/or may reach inside the sensor assembly 1, such that the physical properties of an object can be sensed by sensor element 15 inside the sensor assembly 1, shown in e.g. FIG. 5. The sensor element 15 may comprise a pressure sensor, a temperature sensor and/or a load sensor.

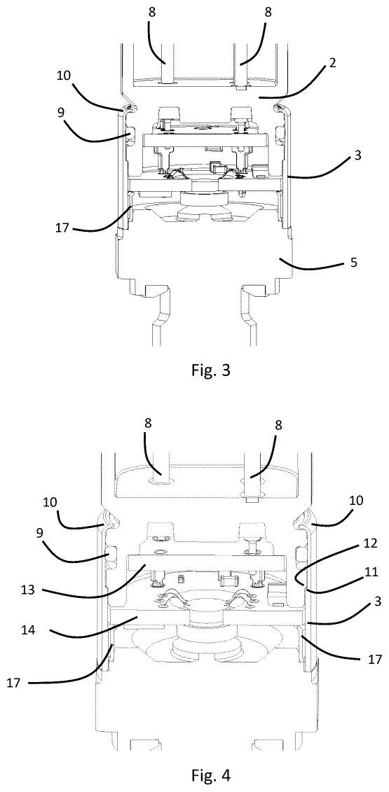

FIG. 3 shows a sectional view of a part of the sensor assembly 1. The bottom portion of the electrical connector 2 is shown partially inserted into the capsule 3. The electrical connector 2 comprises connector pins 8 on its side opposite the capsule 3. An O-ring 9 may be provided between an outer circumference of the electrical connector 2 and a radially inner side of the capsule 3. The capsule 3 may be crimped into an annular grove or a step of the electrical connector 2, such that a crimped capsule portion 10 fixes the capsule 3 to the electrical connector 2. The crimped capsule portion 10 secures the electrical connector 2 to the capsule 3 and locks them permanently in place.

A media connector 5 may be provided close to the bottom of the sensor assembly 1. At the top portion of the media connector 5, a ground ring or ground bracket 17 may be provided around the outer circumference of the media connector 5 and/or within the capsule 3. The ground bracket 17 may provide a contact, preferably an electrical contact, between the media connector 5 and further components of the sensor assembly 1. The ground bracket 17 may combine several different features, such as conducting electrical signals from the capsule 3 to PCBAs 13, 14, EMC/EMI shielding of the components of the sensor assembly 1, providing mechanical stability and/or providing environmental protection to the assembly.

FIG. 4 shows another sectional view of the sensor assembly 1. The electrical connector 2 comprises an annular seat 12 close to its bottom most portion, which is fully inserted in the capsule 3. The annular seat 12 protrudes in a radially outward direction from the electrical connector 2. The annular seat 12 abuts an internal capsule annular seat 11. The internal capsule annular seat 11 protrudes in a radially inward direction from the capsule 3. The internal capsule annular seat 11 may be an edge on the inside of the capsule 3 and acts as a stopper.

Inside the capsule 3, two PCBAs 13, 14 may be provided, a top PCBA 13 and a bottom PCBA 14. The top PCBA 13 may be provided at least partially within the electrical connector 2. The bottom PCBA 14 may be provided below the top PCBA 13 and/or may contact the ground bracket 17. The bottom PCBA 14 may be fixed in an axial direction by the ground bracket 17 and the electrical connector 2. The bottom PCBA 14 may be in direct contact with the ground bracket 17 and the electrical connector 2.

In the embodiment of FIG. 4, the PCBAs 13, 14 and the ground bracket 17 may be provided entirely inside the capsule 3. The PCBAs 13, 14 and the ground bracket 17 may be provided radially inside the capsule 3. Additionally or alternatively, the capsule 3 may extend further in the axial direction than the assembled PCBAs 13, 14 and the ground bracket 17.

FIG. 5 shows a view of the inside of a part of the sensor assembly 1. The top side of the bottom PCBA 14 is visible. A sensor element 15 is arranged in a central hole of the bottom PCBA 14. The sensor element 15 may be arranged concentrically with respect to the bottom PCBA 14, wherein preferably a gap may be provided between the sensor element 15 and the bottom PCBA 14. Wire bonds 16 may be provided for connecting the sensor element 15 to the bottom PCBA 14. The wire bonds 16 may bridge the gap between the sensor element 15 and the bottom PCBA 14.

The ground bracket 17 may be provided below and/or adjacent to the bottom PCBA 14. The ground bracket 17 may comprise at least one and preferably two ground bracket keys 18, which may be arranged on opposing radial outer potions of the ground bracket 17. The ground bracket keys 18 may be inserted into bottom PCBA key slots 19, provided in the radially outer circumference of the bottom PCBA 14.

FIG. 6 shows another view of the inside of a part of the sensor assembly 1. The ground bracket keys 18 are shown inserted into the bottom PCBA key slots 19 of the bottom PCBA 14. The ground bracket keys 18 fix the bottom PCBA 14 with respect to the ground bracket 17. The ground bracket keys 18 may provide a snap fit between the ground bracket 17 and the bottom PCBA 14. The bottom PCBA key slots 19 make it possible to keep the outer diameter of the assembled bottom PCBA 14 and ground bracket 17 at a minimum.

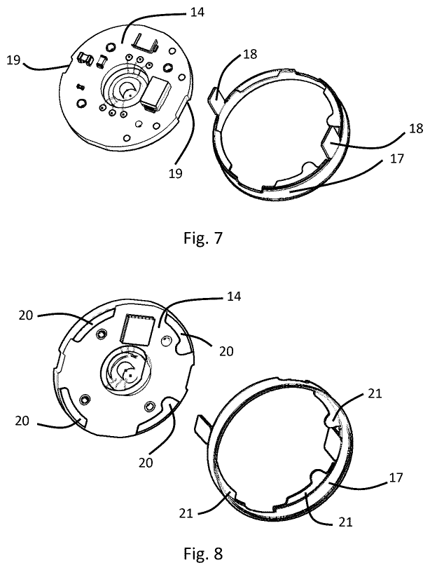

FIG. 7 shows an exploded view of parts of the inside of the sensor assembly 1. The bottom PCBA 14 is shown next to the ground bracket 17. As can be seen from the two components, the bottom PCBA key slots 19 are arranged at positions corresponding to the positions of the ground bracket keys 18 of the ground bracket 17. The ground bracket 17 may be a ring-shaped, toroidal component. The bottom PCBA 14 may be a circular and flat component.

FIG. 8 is another exploded view of the inside of the sensor assembly 1. Here, the bottom PCBA 14 is shown from their bottom side. The bottom side of the bottom PCBA 14 comprises a PCBA ground connection portion 20. The PCBA ground connection portion 20 may itself comprise a number of preferably identical sub-portions, which may be arranged around the circumference of the bottom PCBA 14.

The ground bracket 17 may comprise a matching ground bracket connection portion 21, which is at least partly insertable into the PCBA ground connection portion 20. In the embodiment of FIGS. 7 and 8, the ground bracket connection portion 21 and the PCBA ground connection portion 20 comprise four preferably identical subcomponents, which are preferably arranged at e.g. 90° angles with respect to each other and around the circumference of the respective component. Other suitable numbers of ground bracket connection portions 21 and corresponding PCBA ground connection portions 20 may be present in other embodiments.

The ground bracket connection portion 21 electrically connects the ground bracket 17 to at least one of the PCBAs 13, 14 and/or to the capsule 3. The ground bracket connection portion 21 may be electrically connected, preferably soldered, to the bottom PCBA 14. Alternatively or additionally, the ground bracket 17 and/or the capsule 3 may be electrically connected, preferably welded, to the media connector 5 shown in e.g. FIG. 3.

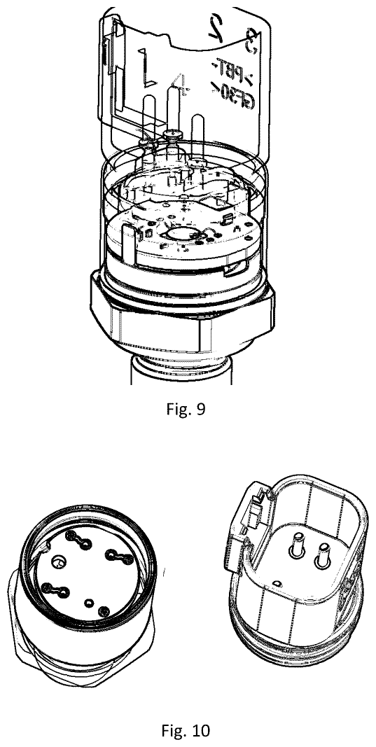

FIG. 9 is a partially transparent view of the inside of the sensor assembly 1, showing the placement of the bottom PCBA 14 and the ground bracket 17 between the electronic connector 2 and the media connector 5. The capsule 3 may be in contact with the ground bracket keys 18 of the ground bracket 17, such that the inside of the capsule 3 presses against the radial outsides of the ground bracket keys 18. The ground bracket keys 18 are thus pressed against the bottom PCBA 14 and/or the electrical connector 2.

FIG. 10 shows perspective views of the electric connector 2 together with some other components of the sensor assembly 1.

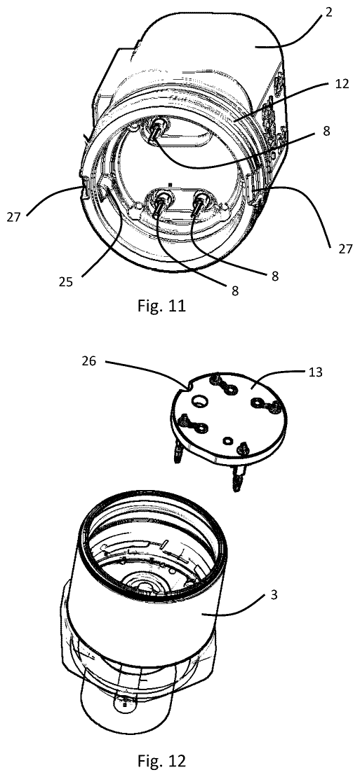

FIG. 11 shows a perspective view of the electric connector 2. The connector pins 8 are shown in a recessed portion of the electric connector 2. The connector pins 8 can be arranged in any pattern. Embodiments with different numbers of connector pins 8 are also conceivable. The connector pins 8 may be arranged in a recessed portion bound by the annular seat 12.

The electrical connector 2 may comprise electrical connector keys 25 and/or electrical connector key slots 27 for coupling the electrical connector 2 to other components of the sensor assembly 1.

The electrical connector key slot 27 of the electrical connector 2 may accommodate the ground bracket key 18 shown in e.g. FIG. 7. The electrical connector key slot 27 may be a recessed portion at an outer circumference of the electrical connector 2 into which the ground bracket key 18 may be inserted at least partially. In the embodiment of FIG. 11, two electrical connector key slots 27 are shown, which interact with two corresponding ground bracket keys 18. Embodiments with 1, 2, 3 or any other suitable number of connector key slots 27 and matching ground bracket keys 18 are also conceivable.

The electrical connector key slot 27 may be an indentation to secure the connector 2 such that it cannot be turned once inserted into the capsule 3 shown in other figures. There may be two swaged portions at the sides of the capsule 3, which press material of the capsule 3 into the connector key slot 27 to fixate the capsule 3 to the connector key slot 27 in a swaging and/or crimping process.

The electrical connector key 25 is an orientation feature, which ensures that the top PCBA 13 and the top PCBA key slot 26 are aligned correctly, in particular during assembly. The electrical connector key 25 and the top PCBA key slot 26 are not locking features. They just ensure the top PCBA 13 is turned the right way during assembly, providing a poke yoke function. The features that secure the electrical connector 2 from turning are the ground bracket keys 18 and the connector key slot 27.

FIG. 12 shows an exploded view of a portion of the sensor assembly 1. The top PCBA 13 comprises one or more top PCBA key slots 26, into which e.g. the electrical connector key 25 shown in FIG. 11 can be inserted for fixing the corresponding components to each other. This ensures that the top PCB 13 is oriented the right way during assembly, e.g. during soldering of connector pins 8. The top PCBA 13 can be fully inserted into the capsule 3.

The electrical connector key 25 and the top PCBA key slot 26 secure the electric connector 2 such that it cannot turn and/or twist inside the capsule 3 and the electric connector 2 is also locked to the PCBA 13, 14. Features 25 and 26 may therefore not be locking features, but only ensure the PCBAs are turned in the right way during assembly. The features that secure the electric connector 2 from turning may be the ground bracket key 18 and the electrical connector key slot 27.

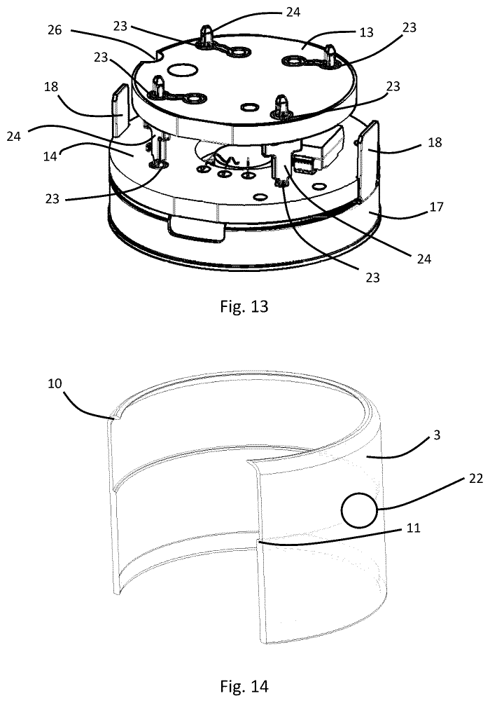

FIG. 13 shows a detailed view of the inside of the sensor assembly 1, wherein the ground bracket 17 is connected to the bottom PCBA 14. The bottom PCBA 14 may be connected to the top PCBA 13 via PCBA connection holes 23 and PCBA connection pins 24. In the embodiment of FIG. 13, a total of four PCBA connection pins 24 and corresponding PCBA connection holes 23 is shown. However, the number of PCBA connection pins 24 and corresponding PCBA connection holes 23 may be any suitable number of pins and corresponding holes. The connection pins 24 distance the top PCBA 13 from the bottom PCBA 14 and may provide an electrical connection between said components.

The bottom PCBA 14 may comprise a bottom PCBA key slot 19 for accommodating the ground bracket key 18. The same ground bracket key 18 may therefore be inserted into the electrical connector key slot 27, the top PCBA key slot 26 and/or the bottom PCBA key slot 19.

FIG. 14 shows a detailed view of the capsule 3. The capsule 3 may be a substantially hollow cylindrical and/or toroidal component. The capsule 3 may comprise a crimped capsule portion 10 at its upper edge. It may comprise an internal capsule annular seat 11 at its radially inner side, preferably approximately halfway between its upper and lower edge. The internal capsule annular seat 11 may be the only seat of the capsule 3. There may be no other seat and/or only a uniformly curved outer surface 22 on the outside of the capsule 3.

The outer surface 22 of the capsule 3 may have a uniform outer radius. The capsule 3 may comprise a lower cylindrical portion with uniform wall thickness, an upper portion with a reduced and also uniform wall thickness and the crimped capsule portion 10.

The upper crimped capsule portion 10 secures the electrical connector 2 to the capsule 3. The capsule 3 may be crimped in a radially inwards direction, once the electrical connector 2 has been inserted at least partially into the capsule 3, as shown in e.g. FIG. 3. The electrical connector 2 may comprise a grove, recess or a step, preferably extending in a circumferential direction of the electrical connector 2. The upper crimped capsule portion 10 may be crimped into this grove or step of the electrical connector 2.

The lower cylindrical portion facilitates the mounting of e.g. labels and/or the provision of engraved information such as text information on the capsule 3.

The capsule 3 may be a cold drawn component. The cold drawing of the capsule 3 facilitates its manufacture while its uniformly cylindrical outside provides a smooth surface for visual identifiers such as labels or engravings.

The invention is also directed at a method for assembling the sensor assembly 1. The method comprises the steps of
connecting the ground bracket 17 to the media connector 5;
connecting the capsule 3 to the media connector 5;
inserting the PCBA 13, 14 into the capsule 3; and
inserting the electrical connector 2 at least partially into the capsule 3.

The method may comprise additional or alternative steps. The assembly steps may depend on the features of the actual sensor assembly. Any features mentioned regarding the sensor assembly may be assembled during the assembly method. The method steps may be performed in any logically possible order. The method may comprise sub-assembly steps, which may provide only portions of the sensor assembly 1.

The assembly method may be divided into three sub-assembly steps for assembling a top assembly, a bottom assembly, and the final assembly. The top assembly may comprise the steps of
mounting PCBA connection pins 24 in top PCBA 13;
placing top PCBA 13 into electrical connector 2 and soldering connector pins 8 to top PCBA 13;
mounting O-ring 9 on electrical connector 2;
pressing electrical connector 2 into capsule 3; and
swaging and/or crimping capsule top edge so it becomes crimped capsule portion 10 to secure electrical connector 2.

The bottom assembly may comprise the steps of
welding sensor element 15 to media connector 5;
placing ground bracket 17 on bottom PCBA 14 such that the ground bracket key 18 engages with the bottom PCBA key slot 19 and then soldering, preferably reflow soldering, the ground bracket 17 to the bottom PCBA 14;
placing ground bracket 17, preferably with bottom PCBA 14 mounted, on media connector 5 and welding them together; and
wire bonding sensor element 15 to bottom PCBA 14.

The final assembly may comprise the steps of aligning and pressing together the top assembly to the bottom assembly, such that the ground bracket key 18 engages the electrical connector key slot 27 and the capsule 3 sits on the media connector 5; and welding capsule 3 to media connector 5.

An alternative assembly method may comprise alternative steps, such that the capsule 3 is moved to the bottom assembly and can be welded to the media connector 5 before the electrical connector 2 is pressed into the capsule 3.

Here, the top assembly may comprise the steps of
mounting the PCBA connection pins 24 in the top PCBA 13;
placing the top PCBA 13 into the electrical connector 2 and soldering the connector pins 8 to the top PCBA 13; and
mounting the O-ring 9 on the electrical connector 2.

The bottom assembly may comprise the steps of
welding the sensor element 15 to the media connector 5;
placing the ground bracket 17 on the bottom PCBA 14, such that the ground bracket key 18 engages with the bottom PCBA key slot 19 and then
soldering, preferably reflow soldering, the ground bracket 17 to the bottom PCBA 14;
placing ground bracket 17, preferably with bottom PCBA 14 mounted, on media connector 5 and welding them together;
wire bonding sensor element 15 to the bottom PCBA 14; and
placing capsule 3 on to media connector 5 and welding them together.

The final assembly may comprise the steps of
aligning and pressing together the top assembly to the bottom assembly, such that the ground bracket key 18 engages the electrical connector key slot 27;
pressing electrical connector 2 into the capsule 3; and
swaging and/or crimping the capsule 3 top edge so it becomes crimped capsule portion 10 to secure the electrical connector 2.

The individual method steps may be performed in different orders, where logically possible. Further method steps related to providing the presently described sensor assembly may also be part of the assembly method.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A sensor assembly comprising an electrical connector with an annular seat, media connector, at least one PCBA with a bottom PCBA key slot, a ground bracket with at least one ground bracket key inserted into the bottom PCBA key slot and at least one capsule, wherein an internal capsule annular seat abuts the annular seat.

2. The sensor assembly according to claim 1, wherein the outside of the capsule consists of a lower uniformly cylindrical portion and an upper crimped capsule portion and/or that the capsule is cold drawn.

3. The sensor assembly according to claim 2, wherein the upper crimped capsule portion secures the electrical connector to the capsule.

4. The sensor assembly according to claim 1, wherein the electrical connector comprises an electrical connector key slot accommodating the ground bracket key.

5. The sensor assembly according to claim 1, wherein the PCBA comprises a bottom PCBA key slot accommodating the ground bracket key.

6. The sensor assembly according to claim 1, wherein the ground bracket comprises at least one ground bracket connection portion electrically connecting the ground bracket to the PCBA and/or to the capsule and/or media connector.

7. The sensor assembly according to claim 1, wherein two PCBAs are provided, a top PCBA and a bottom PCBA, which are connected to each other via PCBA connection pins.

8. The sensor assembly according to claim 1, wherein the sensor assembly is a pressure, load and/or temperature sensor assembly.

9. The sensor assembly according to claim 1, wherein the PCBA and the ground bracket are entirely provided inside the capsule relative to a radial direction of the capsule.

10. The sensor assembly according to claim 1, wherein the ground bracket providing an electrical connection between the PCBA, the capsule, and the media connector for shielding the PCBA against EMC/EMI noise.

11. A method for assembling the sensor assembly according to claim 1, comprising the steps of
connecting the ground bracket to the media connector;
connecting the capsule to the media connector;
inserting the PCBA into the capsule; and
inserting the electrical connector at least partially into the capsule.

12. The sensor assembly according to claim 2, wherein the electrical connector comprises an electrical connector key slot accommodating the ground bracket key.

13. The sensor assembly according to claim 3, wherein the electrical connector comprises an electrical connector key slot accommodating the ground bracket key.

14. The sensor assembly according to claim 2, wherein the PCBA comprises a bottom PCBA key slot accommodating the ground bracket key.

15. The sensor assembly according to claim 3, wherein the PCBA comprises a bottom PCBA key slot accommodating the ground bracket key.

16. The sensor assembly according to claim 4, wherein the PCBA comprises a bottom PCBA key slot accommodating the ground bracket key.

17. The sensor assembly according to claim 2, wherein the ground bracket comprises at least one ground bracket connection portion electrically connecting the ground bracket to the PCBA and/or to the capsule and/or media connector.

18. The sensor assembly according to claim 3, wherein the ground bracket comprises at least one ground bracket connection portion electrically connecting the ground bracket to the PCBA and/or to the capsule and/or media connector.

19. The sensor assembly according to claim 4, wherein the ground bracket comprises at least one ground bracket connection portion electrically connecting the ground bracket to the PCBA and/or to the capsule and/or media connector.

20. The sensor assembly according to claim 5, wherein the ground bracket comprises at least one ground bracket connection portion electrically connecting the ground bracket to the PCBA and/or to the capsule and/or media connector.
